(19) United States
(12) Patent Application Publication
(10) Pub. No.: US 2019/0264866 A1
(43) Pub. Date: Aug. 29, 2019

(54) Apparatus for hanging holiday lights or ornaments safely without using a ladder

(71) Applicants: Gregory Richard Raab, Highlands Ranch, CO (US); David Hornick, Englewood, CO (US); Anita Raghunath, Highlands Ranch, CO (US)

(72) Inventors: Gregory Richard Raab, Highlands Ranch, CO (US); David Hornick, Englewood, CO (US); Anita Raghunath, Highlands Ranch, CO (US)

(21) Appl. No.: 16/261,520

(22) Filed: Jan. 29, 2019

Related U.S. Application Data
(60) Provisional application No. 62/623,272, filed on Jan. 29, 2018.

(51) Int. Cl. F16M 13/02; A47G 33/00; F16B 1/00; F21V 21/096; F21V 21/088

(52) U.S. Cl. CPC F16M 13/022; A47G 33/00; F16B 1/00; E04D 13/00; F21V 21/088; F16B 2001/0035; F21V 21/096

(57) ABSTRACT

A method and apparatus for safely hanging holiday lights/ornaments on buildings, which comprises supports, hooks, and a hanger. The support is typically a ferromagnetic or weak magnet core in a male or female fashion and a screw-hole to attach to eaves, other parts of a building, or another cross support. The hanger is attached to a paint stick or broom handle, has an orientated strong or electro, magnet in a male or female shape matching against the hook. The hook, directly or indirectly, connects to holiday lights, ornament, etc, has a weak orientated magnet, along with opposing sides designed to connect to both the support and the hanger. Assuming a string of holiday lights, the first hook is attached manually to the hanger and the hook is then attached to the first support. While the string will dangle down with hooks interspersed, the hanger can magnetically grab the next hook, and then be used to attach that hook to the next support.

### CLASSIFICATIONS

F21V17/105 Fastening of component parts of lighting devices, e.g. shades, globes, refractors, reflectors, filters, screens, grids or protective cages characterised by specific fastening means or way of fastening using magnets
F21S4/10 Lighting devices or systems using a string or strip of light sources with light sources attached to loose electric cables, e.g. Christmas tree lights
F16B2001/0035 Devices for securing together, or preventing relative movement between, constructional elements or machine parts by the use of a magnetic material

### F16B45/00 Hooks; Eyes

F21W2121/004 Use or application of lighting devices or systems for decorative purposes, not provided for in codes F21W2102/00-F21W2107/00 mounted on the exterior of houses or other buildings to illuminate parts thereof

### BACKGROUND

### Field of the Invention

Hoox is an apparatus for safely hanging holiday lights or ornaments higher than arms reach. More particularly, this system is capable of safely working with lights or ornaments hanging in the air on a wire or cord, without a ladder.

### Description of the Related/Prior Art

To date, all attempts to hang holiday decoration have focused on the hanger, with an occasional effort on the actual process of hanging. The problem with all of these is that they will all require somebody who is hanging decorations up high to get up on Ladders and/or Roofs, typically during icy times or the hanging mechanism is so laborious that it is much easier and faster to revert to climbing a ladder or the roof. Many injuries and death occur yearly due to these dangerous situations.

### SUMMARY

In one embodiment, this invention relates to having supports and hooks for holding items securely to a building or a structure, but can quickly and easily be hung and later taken down without ladders.

This will typically be used to hang items, e.g. lights, to display at different times of the year for holidays such as Valentines day, Independence Day, Halloween and Christmas, signs, pictures, etc.

### BRIEF DESCRIPTION OF THE DRAWINGS

FIG. 1 shows a bottom view of a support with a hole for a screw.

FIG. 2 shows a perspective view of a support.

FIG. 3 shows a top view of a support with a counter sunk hole in the middle.

FIG. 4 shows a side view of a Hook.

FIG. 5 shows a front view of a Hook.

FIG. 6 shows a perspective view of a Hook.

FIG. 7 shows a perspective view of a Hanger.

FIG. 8 shows a side view of a Hanger.

FIG. 9 shows a bottom view of a Hanger.

### DETAILED DESCRIPTION

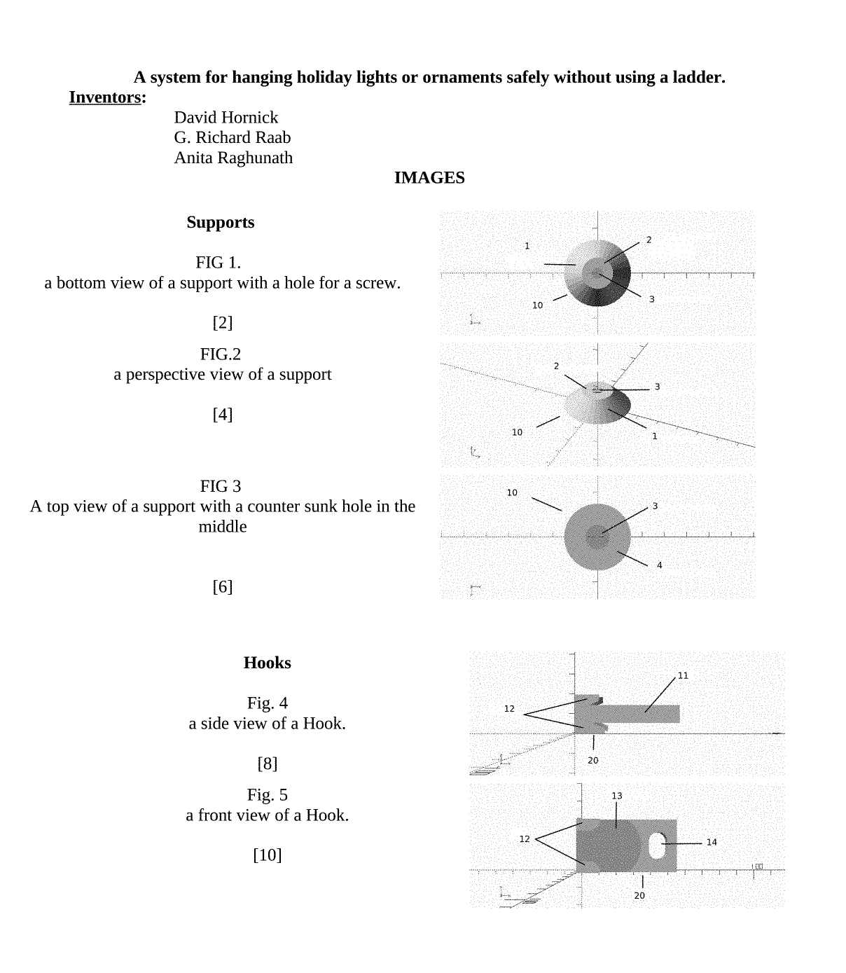

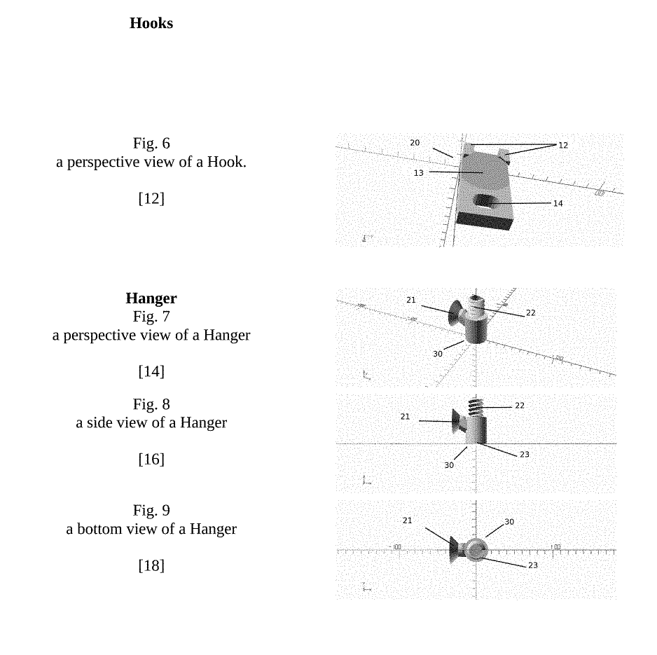

Hoox is a 3 part system; FIGS. 1-3 shows the Support, FIGS. 4-6 shows the Hook and FIGS. 7-9 show the Hanger.

1) The Support 10, which is permanently attached to a surface, and used to hold the Hook 20.

2) The Hook 20, which is used to connect an item, such as light/decoration, to the Support 10.

3) And the Hanger 30, which is used to connect/disconnect the Hook 20 to/from the Support 10.

The simplest implementation of the Support 10 is a flattened truncated cone 1, with a countersunk hole 3 in the middle for a screw attachment. The material is ferrous-magnetic material mixed with plastic resign or a piece of ferrous-metal or magnet embedded in plastic. The shape allows it to serve as a secured holding device for the Hook 20 as well as discouraging water, snow, and ice build-up. The metal or magnet, allows for feeling the attraction as the Hook 20 gets close.

The Hook 20 uses a similar sized magnet 13 encased in plastic, or a mixture of ferrous−magnetic mixed in the plastic. The Hook 20 must have a means of attachment to the light/decoration. This could be a simple hole 14 on the bottom to pass a tie through or actually have the light strand/decoration embedded in the bottom. Since the light/decoration is under the Hook 20, it applies downward pressure on it and helps hold the Hook 20 on the Support 10.

The Hook 20 can take multiple shapes, though the simplest is basically a rectangular box with 2 opposing faces and light decoration at the bottom. The side that faces the Support 10 has a female portion 14 designed to fit over the Support 10. It actually uses a physical support with connection to the Support 10, while the magnet is used mostly by the Hanger 30. The opposing face will then match up with the Hanger 30. In general, this will simply be the opposite of the Support/Hook face. So, each face on the hook 20 can be mirror images of the other.

The Hanger 30 is designed to go on the end of a paintbrush/broom pole which have a standard screw fixture 23 of ¾″×5″. From there, it will also support a strong magnet 21, either rare earth, or electro-magnet, which is shaped to match the Hook 20. In general, it looks like a mirror image of the Support 10. With this approach, it allows the Hanger 30 to easily match up and grab the Hook 20, even when it is hanging in the air on a light strand.

Another requirements is that any magnets used on the Support 10, Hook 20 and Hanger 30 be lined up properly with regard to N-S. Since magnets are not easily pulled apart, but are easily sheared, the magnets are designed to support guiding the Pole-Hanger/Hook attachment while the Hook 20 hangs in the air and then the Hook/Support attachment while the Hook 20 is attached to the Pole-Hanger. To separate the Pole-Hanger from the Hook 20, simply pull it down/sideways to shear it, or if electromagnet, turn off the magnet.

| Publication | Priority | Publication | | |
|---|---|---|---|---|
| number | date | date | Assignee | Title |
| CA2087377C | 1993 Jan. 15 | 1998 Mar. | William Brian | Method of and apparatus for |
| | | 31 | Dougan | suspending christmas lights from |
| | | | | eaves on a house |
| U.S. Pat. No. 6,338,460B1 | 1999 Dec. 30 | 2002 Jan. | Donald D. Rumpel | Lap type siding mounted Christmas |
| | | 15 | | light clip |
| U.S. Pat. No. 6,352,291B1 | 2000 Jun. 8 | 2002 Mar. 5 | Michael Vincent | Implement and system for remotely |
| | | | Tortajada | affixing and removing decorations |
| | | | | and other objects |
| U.S. Pat. No. 6,425,614B1 | 2000 Jun. 14 | 2002 Jul. | The Christmas | Light string attachment accessory |
| | | 30 | Light Company | |
| U.S. Pat. No. 6,827,379B2 | 2001 Nov. 16 | 2004 Dec. 7 | Micro Plastics, | Quick mounting clip system for |
| | | | Inc. | hanging decorations and Christmas |
| | | | | lights |
| U.S. Pat. No. 6,536,727B1 | 2002 Feb. 7 | 2003 Mar. | The Christmas | Christmas light clip |
| | | 25 | Light Company | |
| | | | Inc. | |
| U.S. Pat. No. 6,572,062B1 | 2002 Jun. 17 | 2003 Jun. 3 | The Christmas | Gutter clip for attachment of linear |
| | | | Light Company | systems |
| | | | Inc. | |
| U.S. Pat. No. 6,883,768B1 | 2003 Oct. 2 | 2005 Apr. | Denis Morin | Device for hanging decorative |
| | | 26 | | fixtures |
| USD537330S1 | 2006 Feb. 3 | 2007 Feb. | Emerald | Clip |
| | | 27 | Innovation LLC | |
| USD564347S1 | 2007 Jun. 29 | 2008 Mar. | Jamie Limber | Clip for attachment of linear systems |
| | | 18 | | |
| U.S. Pat. No. 7,669,827B2 | 2008 Jan. 31 | 2010 Mar. 2 | Remberto D | String light hanging kit |
| | | | Urrutia | |
| U.S. Pat. No. 8,459,712B2 | 2008 Jan. 17 | 2013 Jun. | Home Depot Usa, | Apparatus for coupling and |
| | | 11 | Inc. | decoupling clips |
| U.S. Pat. No. 8,015,755B2 | 2009 Mar. 5 | 2011 Sep. | Bradley Miller | Integrated housing mounting system |
| | | 13 | | |
| U.S. Pat. No. 8,888,337B2 | 2009 Oct. 20 | 2014 Nov. | Adams Mfg. Corp. | Decorative light clip |
| | | 18 | | |
| USD772027S1 | 2010 Sep. 17 | 2016 Nov. | Dyno Seasonal | Telescoping pole for hanging lights |
| | | 22 | Solutions L.L.C. | |
| USD756764S1 | 2011 Dec. 13 | 2016 May | Jamie Limber | Temporary support device for |
| | | 24 | | ornamental lighting |
| U.S. Pat. No. 9,964,291B1 | 2011 May 4 | 2018 May 8 | Rene Del Rio | Holiday light string hanging device |
| U.S. Pat. No. 8,308,323B2 | 2015 Apr. 22 | 2012 Nov. | Darryl Holland | Magnetic Light Clip |
| | | 13 | | |
| U.S. Pat. No. 7,914,185B2 | 2015 Nov. 4 | 2011 Mar. | Brenda A. Moore | Christmas light clips with magnets |
| | | 29 | | |
| U.S. Pat. No. 8,490,936B2 | 2017 Feb. | 2013 Jul. | Lance Rinck | Decorative light hanging system |
| | 27 | 23 | | |

| Publication | Publication Date | Title |
|---|---|---|
| U.S. Pat. No. 5,188,332A | 1993 Feb. 23 | Sign holder |
| U.S. Pat. No. 5,542,636A | 1996 Aug. 6 | Clips for supporting miniature Christmas lights at any of a plurality |
| | | of locations |
| U.S. Pat. No. 5,707,136A | 1998 Jan. 13 | Multiple light systems |
| U.S. Pat. No. 5,788,362A | 1998 Aug. 4 | Light string fixing structure |
| U.S. Pat. No. 6,109,765A | 2000 Aug. 29 | Variable-position decorative light mounting system |
| U.S. Pat. No. 6,050,703A | 2000 Apr. 18 | Sliding Christmas tree light mounting assembly |
| U.S. Pat. No. 6,352,291B1 | 2002 Mar. 5 | Implement and system for remotely affixing and removing |
| | | decorations and other objects |
| U.S. Pat. No. 9,926,708B1 | 2018 Mar. 27 | Magnetic fasteners and wall cover system |
| U.S. Pat. No. 9,284,973B2 | 2016 Mar. 15 | Magnetic Wall Anchoring System |

Similar Documents (9)

| Publication | Publication Date | Title |
|---|---|---|
| US5188332A | 1993 Feb. 23 | Sign holder |
| US554263A | 1996 Aug. 6 | Clips for supporting miniature Christmas lights at any of a plurality |
| | | of locations |
| US5707136A | 1998 Jan. 13 | Multiple light systems |
| US5788362A | 1998 Aug. 4 | Light string fixing structure |
| US6109765A | 2000 Aug. 29 | Variable-position decorative light mounting system |
| US6050703A | 2000 Apr. 18 | Sliding Christmas tree light mounting assembly |
| US6352291B1 | 2002 Mar. 5 | Implement and system for remotely affixing and removing |
| | | decorations and other objects |
| US9926708B1 | 2018 Mar. 27 | Magnetic fasteners and wall cover system |
| US9284973B2 | 2016 Mar. 15 | Magnetic Wall Anchoring System |

What is claimed is:

1) A system, comprising:
a Support with a ferromagnetic material or weak magnet core, that is shaped, typically in a male/female fashion, to match one side of the Hook;
a Hanger, with a bored and threaded base to attach to an extension pole, and a projection shaped similar to the Support with a strong magnetic or electromagnetic core and an end, again in a male/female fashion, matched to the other side of the Hook;
a Hook with a means of attaching wires/lights/ornaments underneath and then shaped on 2 opposing sides, typically in a male/female fashion, matched to the Support on 1 side and to the Hanger on the other side, with a weak magnetic core orientated to attract both Support and Hanger, allowing the Hanger to be able to physically lift up the Hook/attachment and for the Hook to be held in place by the Support.

2) The system as defined in claim 1 wherein said Support is a flattened truncated cone with the base pointed out, allowing snow, ice, & rain to run off, and with a countersunk hole in the middle of the base, for singular attachment to eaves, walls, gutters, etc.

3) The system as defined in claim 1 wherein said Support as defined in claim 2 has multiple Supports attached to or formed on a spar, at predetermined spacing such as 1 foot/33 cm, typically matching common gutter lengths to attach to eaves, fascia, etc such as 10 feet/3 meters.

4) The system as defined in claim 1 wherein said Hanger has a cylindrical base that is bored and female threaded enabling it to be attached to an extension pole such as a paint-brush pole or a standard broom handle.

5) The system as defined in claim 1 wherein said Hanger has a side projection that contains a flattened truncated cone similar or identical to the Support, with the base pointed out, and an embedded strong magnet reversed from the Support; The magnet can be a passive magnet such as Rare Earth or FE6, or an electromagnet.

6) The system as defined in claim 1 wherein said Hook with 2 female/male parts that match at the top of the Hook to the Support and Hanger and has the ability to lift up with the Hanger, as well as be supported by the Support.

7) The system as defined in claim 1 wherein said Hook will either have the majority of the weight below the support and hook to provide orientation, OR the Female/Male parts of Support/Hanger or Hanger/Hook are designed so that orientation is locked in.

8) The system as defined in claim 1 wherein said Hook with 2 holes above the base of the Hook, penetrating from side 1 through to the other side; 2 Holes directly below the above 2 holes that penetrate from the base up to the aforementioned holes.

9) The system as defined in claim 1 wherein said Hook with electrical wires running from edge sides to the next Hook at predetermined spacing, combined with the ability to plug-in lights or electrical ornaments to the base, with the weight hanging below.

10) The system as defined in claim 1 wherein said Hook may use 2 or more magnets which are offset so that 1 or more magnets works with the Support, while a different 1 or more magnets work with the Hanger.
